(19) United States
(12) Patent Application Publication
(10) Pub. No.: US 2009/0126569 A1
(43) Pub. Date: May 21, 2009

(54) PROTECTIVE SCREEN FOR AIR-HANDLING EQUIPMENT

(76) Inventor: Harold Russell, Grand Junction, CO (US)

Correspondence Address: HOLLAND & HART, LLP, P.O BOX 8749, DENVER, CO, 80201, US

(21) Appl. No.: 11/941,697

(22) Filed: Nov. 16, 2007

(51) Int. Cl. B01D 46/02; B01D 50/00

(52) U.S. Cl. 95/279; 55/385.1; 55/369; 95/278; 95/281

(57) ABSTRACT

A protective screen is provided for use with air-handling devices, including air conditioners and evaporative coolers. In one aspect the protective screen is comprised of a generally flexible mesh material. The screen is secured around the exterior of the air-handling device, closely adjacent any inlet openings. One or more drawstrings are provided to fit the screen to the air-handling device and prevent unintentional removal therefrom. The protective screen may be periodically removed and cleaned prior to reuse.

### BACKGROUND

Air-handling equipment, such as air conditioners and evaporative coolers equipment, are commonly found in residential and commercial settings. Such equipment are typically comprised of units located outside of the home or business and include an exterior cover having inlet openings, that lead to an inner chamber. One or more various air-induction devices are located within the inner chamber; for drawing air through the inlet openings and into the inner chamber. Frequently, the inlet openings are merely provided with louvers or other structural members that merely prevent the passage of large objects from outside of the air-handling device to the inner chamber. Other structures, such as evaporative pads and the like are commonly positioned directly behind the inlet openings.

Unfortunately, as air is drawn through the inlet openings and into the inner chamber, particulate matter including dirt, leaves, and other debris become engaged with the structures at the inlet opening. This can greatly restrict air flow into the air-handling device, limiting its efficiency and ability to run properly. Much of the debris adheres to the contoured surfaces of the louvers, evaporative pads; and the like, making it difficult to easily or effectively remove the debris from the air-handling device. Often times, the air-handling devices must be partially dismantled and cleaned from the inside out. Such activities can be quite laborious and costly when handled by third-parties.

Accordingly, what is needed is novel system and method of preventing common debris from engaging and clogging structural features of air-handling devices. Such a system and method should, preferably, be relatively inexpensive, simple to manufacture and implement, and easy to maintain over a long useful life.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The protective screen of the present invention is provided for use with air-handling devices, having covers with exterior surfaces, inlet openings through the cover, and inner chambers containing on or more various devices for drawing air through the inlet openings and into the inner chamber. In one aspect, the protective screen is generally comprised of a flexible mesh material. The protective screen is formed to have first and second opposing surfaces, first and second end portions, and a drawstring that is disposed at least partially within a partially enclosed channel, adjacent the first end portion of the screen. Manipulation of the drawstring permits the first end portion of the protective screen to be selectively constricted. In use, the protective screen is position with the second surface closely adjacent to the inlet openings of the air-handling device so that particulate matter in the air is substantially prevented from passing the first surface of the screen and engaging the exterior surface of the air-handling device.

In one aspect, the protective screen may be formed in the shape of a closed loop with an opening defined at least at its second end portion. The opening is shaped in size to selectively pass the air-handling therethrough. The protective screen may be easily removed from the air-handling device and cleaned of any debris adhering thereto.

These and other objects of the present invention will be apparent after consideration of the Detailed Description and Figures herein.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a perspective view of one embodiment of the protective screen;

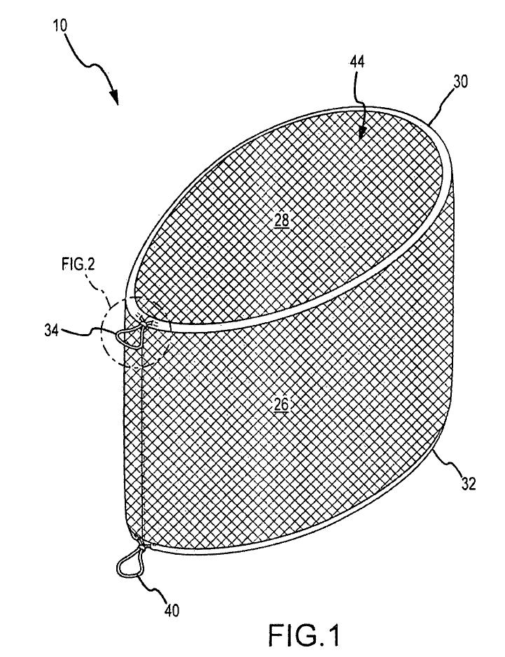

FIG. 2 depicts an isometric view of a drawstring and cinch stop potions of the protective screen depicted in FIG. 1;

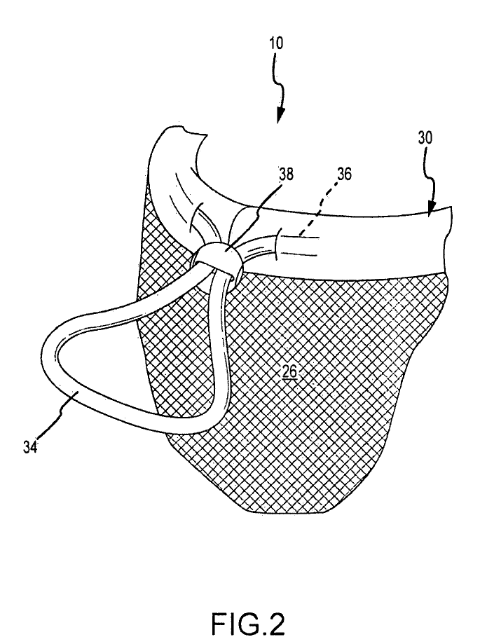

FIG. 3 depicts the protective screen of FIG. 1 and one contemplated method of use with an air-handling device; and

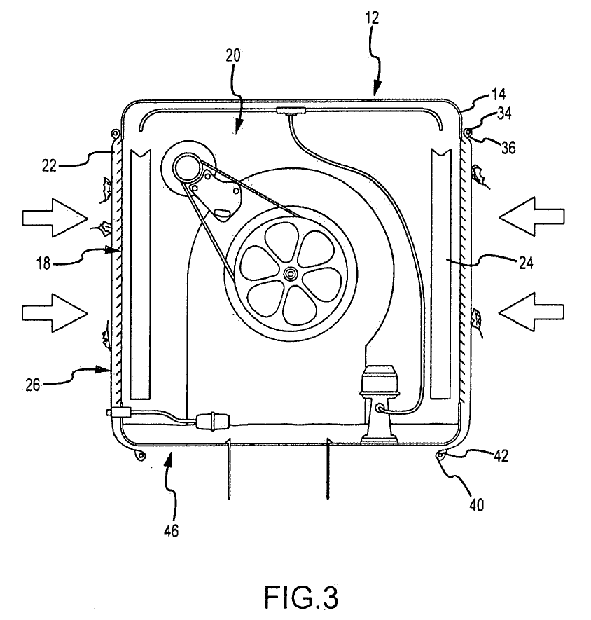

FIG. 4 depicts one manner in which debris may be removed form a surface of the protective screen using a fluid.

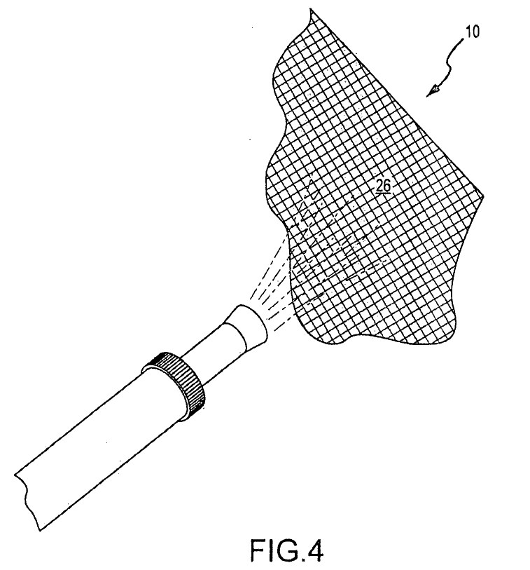

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

A protective screen 10 is generally provided for use with an air-handling device 12, such as an air conditioner, evaporative cooler, or the like. Typically, a common air-handling device 12 will be generally provided within an exterior component that is positioned out of doors, adjacent to a home, business or other such structure. The exterior component is typically provided with a cover 14 having an exterior surface 16, inlet openings 18 formed through the cover 14, and an inner chamber 20 that contains equipment for drawing air through the inlet openings 18 and into the inner chamber 20. Such equipment will frequently be comprised of a motor and one or more fans that are oriented to draw air into the unit in a desired fashion. Louvers 22 or other similar structures may be located within the inlet openings 18. Evaporative pads 24, cooling fins or other related media carrier are typically positioned within the inner chamber 20, closely adjacent to the inlet openings 18.

The protective screen 10 is preferably comprised of a generally flexible mesh material. Such material may be derived from various synthetic or natural substances. However, it will be desirable that the material selected be capable of withstanding temperatures and other weather elements common to areas in which the invention is to be used. The, protective screen 10 will have a first surface 26 and a second closing surface 28, a first end portion 30 and an opposite second end portion 32. In a preferred embodiment, a first drawstring 34 is at least partially disposed within a partially enclosed channel 36 formed adjacent the first end portion 30 of the protective screen 10. Opposite end portions of the first drawstring 34 may be left free or secured with one another. In a preferred embodiment, a cinch stop 38 is positioned to be movable along lengths of the free end portions of the first drawstring 34. Other positive stop-type devices may be used. It is merely important that the first drawstring 34 be capable of selectively constricting the first end portion 30 of the protective screen 10. In a preferred embodiment, a second drawstring 40 is disposed at least partially within a partially enclosed channel 42, adjacent the second end portion 32 of the protective screen 10. The second drawstring 40 is provided in a manner similar to that described with respect to the first drawstring 34 and may have its opposite end portions secured with one another using a cinch stop 38 or other such device. In this manner, the second end portion 32 of the protective screen 10 may be selectively constricted using the second drawstring 40 and secured in position using the cinch stop 38.

In at least one preferred embodiment, the protective screen 10 is formed with its opposite end portion secured with one another to form an endless loop with an opening 44 defined by the first end portion 30 of the protective screen 10. Likewise, an opening 46 should be defined by the second end portion 32 of the protective screen 10. The first drawstring 34 and second drawstring 40 should be provided to selectively constrict the openings 44 and 46 to reduce and, inversely, expand the overall size of the protective screen 10, according to various intended uses.

In use, the protective screen 10 should be positioned around the air-handling device 12 so that the second surface 28 of the protective screen 10 is positioned closely adjacent to the inlet openings 18 of the air-handling device 12. Tension should be placed on the first drawstring 34 and second drawstring 40 (when provided) to constrict the end portions of the protective screen 10. This will prevent the unintentional withdrawal of the air-handling device 12 from within the protective screen 10 and should keep the protective screen 10 in position, regardless of wind or other weather phenomena. Preferably, the first end portion 30 and the second end portion 32 of the protective screen 10 will extend just beyond the upper and lower end portions of the cover 14 of the air-handling device 12. In this manner, a more secure position may be obtained for the protective screen 10.

With the protective screen 10 in position, the air-handling equipment 12 may be operated so that air is drawn through the protective screen 10 and the inlet openings 18 of the air-handling device 12. In doing so, it is contemplated that debris, such as leaves, dirt, trash, and the like will accumulate on the first surface 26 of the protective screen 10. Such debris accumulation can restrict through the air-handling device 12 and limit its usability. Accordingly, air-handling device 12 may be turned off while the protective screen 10 is removed therefrom. Particulate matter may then be removed from the first surface 26 of the protective screen 10. It is contemplated that the particulate matter may be removed from the protective screen 10 by vigorously shaking the protective screen 10 or directing a fluid, such as water or air, against the protective screen 10. Such fluids may be directed from the second surface 28 of the protective screen 10 or at an angle, against the first surface 26. Once the protective screen 10 has been cleaned, it may simply be repositioned closely adjacent the air-handling device 12 and reused.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. In combination:
an air-handling device, comprising an exterior surface, inlet openings in said exterior surface, and an inner chamber containing means for drawing air through said inlet openings and into said inner chamber; and
a screen, comprising a generally flexible mesh material, and having first and second opposing surfaces, first and second end portions, and a drawstring disposed at least partially within a partially enclosed channel adjacent the first end portion of said screen so that the first end portion of said screens many be selectively constricted;
said screen being positioned with its second surface closely adjacent the inlet openings of said air handling device so that particulate matter in the air is substantially prevented from passing the first surface of said screen and engaging the exterior surface of said air handling device.

2. The combination of claim 1 wherein said screen is formed in the shape of a closed loop with an opening defined by said second end portion; said opening being shaped and sized to selectively pass said air-handling device there through.

3. The combination of claim 2 wherein said screen is further provided with a second drawstring disposed at least partially within a partially enclosed channel adjacent the second end portion of said screen so that the second end portion of said screen many be selectively constricted.

4. The combination of claim 2 wherein said screen is formed with an opening defined by the first end portion of said screen; said drawstring being positioned so that the opening defined by the first end portion of said screen many be selectively constricted to prevent passage of said air-handling equipment therethrough.

5. The combination of claim 1 wherein said screen completely encircles said air-handling device.

6. The combination of claim 1 wherein said drawstring forms a loop with the use of a cinch lock that is slidably positionable along a length of said drawstring to secure the first end portion of said screen in a constricted position.

7. The combination of claim 3 wherein each of said drawstring and said second drawstring form loops with the use of cinch locks that are slidably positionable along lengths of said drawstring and said second drawstring to selectively secure the first and second end portions of said screen in constricted positions.

8. A method of reducing particulate engagement with air-handling equipment, having an exterior surface, inlet openings in said exterior surface, and an inner chamber, the method comprising:
providing a screen, comprising a generally flexible mesh material, and having first and second opposing surfaces, first and second end portions, and a drawstring disposed at least partially within a partially enclosed channel adjacent the first end portion, of said screen;
positioning said screen around said air-handling device with its second surface closely adjacent the inlet openings of the air-handling device;
placing tension on said drawstring to constrict the first end portion of said screen;
operating the air-handling equipment so that air is drawn through said screen and the inlet openings of said air-handling device;
separating said screen from the air-handling equipment and removing particulate matter from the first surface of said screen.

9. The method of claim 8 wherein the step of removing particulate matter from the first surface of said screen is at least partially performed by directing a fluid against said screen.

10. The method of claim 9 wherein said fluid is water.

11. The method of claim 9 wherein said fluid is air.

12. The method of claim 18 further comprising:
forming said drawstring into a loop using a cinch lock that is slidably positioned along a length of said drawstring; and
securing the first end portion of said screen in a constricted position, by sliding said cinch lock away from distal end portions of said drawstring.

13. The method of claim 12 further comprising:
providing said screen with a second drawstring disposed at least partially within a partially enclosed channel adjacent the second end portion of said screen so that the second end portion of said screen many be selectively constricted.

14. The method of claim 13 further comprising:
forming said second drawstring into a loop using a second cinch lock that is slidably positioned along a length of said second drawstring; and
securing the second end portion of said screen in a constricted position, by sliding said cinch lock away from distal end portions of said second drawstring.
